(19) United States
(12) Patent Application Publication
(10) Pub. No.: US 2007/0033098 A1
(43) Pub. Date: Feb. 8, 2007

(54) METHOD, SYSTEM AND STORAGE MEDIUM FOR CREATING SALES RECOMMENDATIONS

(75) Inventors: Daniel J. Peters, Poughquag, NY (US); Kimberly L. Atherton, Trumbull, CT (US); Glee H. Firth, Birmingham, MI (US); Leo Kluger, New Hempstead, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/161,493

(22) Filed: Aug. 5, 2005

(51) Int. Cl. G06Q 30/00

(52) U.S. Cl. 705/14; 705/26

(57) ABSTRACT

Methods, systems and program products for providing real-time sales recommendations. A user selects a sales offering, and then batch or real-time data feeds of currently available sales offering pricing, availability, performance and data-mined analytics information are transmitted to a real-time data interface. The real-time data interface generates real-time sales recommendations based on the selected sales offering and data feeds. These real-time sales recommendations are determined by defining four distinct sell spaces that include an up-sell space, a down-sell space, and first and second alternative-sell spaces, whereby the real-time sales recommendations include up-sell, down-sell and alternative-sell recommendations. Business rules are used to determine which of the four distinct sell spaces these real-time sales recommendations will occupy. The real-time sales recommendations are continually refreshed and updated, and as such, may be tailored to a user's wants and needs.

### BACKGROUND OF THE INVENTION

1. Field of the Invention

The present invention relates to up-selling, alternative-selling and down-selling in real-time and on demand for permitting marketing, merchandising and sales recommendations for large product sets to be automated and used at the point of execution to condition demand.

2. Description of Related Art

In the sales industry, when a customer, business partner or internal sales staff desires a particular good and/or service, conventional methods of up-selling, alternative-selling, and down-selling other offerings to such customer, business partner or internal sales staff includes scanning other goods and/or services portfolios, and estimating other recommended goods and/or services that provide the customer, business partner or internal sales staff with what they are looking for, in addition to meeting the seller's revenue and profit targets. These approaches typically require sales personnel to have expert knowledge of the offerings and financial benefits, as well as require that the goods and/or services portfolios be small or uncomplicated.

Large scale product offerings and automation use a typical approach to up-selling, alternative-selling, and down-selling, wherein static “parent-child” pairs are created by marketing or product planning personnel who have detailed product knowledge. Often, the “child” in a parent-child pair is the “parent” for a subsequent parent-child pair, such that, the marketing or product planning personnel create a continuous chain of parent-child links, which is essential in creating a sales path for the seller's sales staff, business partner or customer. Since it is the marketing or product planning personnel who create these “parent-child” pairs, the seller's sales team, business partners and/or customers are relieved of the task of determining appropriate parent-child pair(s).

Conventional parent-child pairing evolves from a one-to-one parent-child relationship, or alternatively, to a one-to-several parent-children relationships. In some instances, only up-sell parent-child pairs are created with alternative-sell and/or down-sell parent-child pairs being completely avoided. However, this is undesirable since alternative-sell and/or down-sell relationships are often needed to meet the customer's desires and requirements.

A significant problem with these static parent-child(ren) pairs is that they are manually created and entered into automated systems, which leads to the potential for human error, and they are often limited to a single product family. Additionally, expert resources are required to identify and create parent-child or parent-children pairs. Another significant problem with these static parent-child or parent-children pairs is that they are predetermined and fixed at a specific point in time and remain unchanged for an indeterminate length of time, even though certain criteria relating to such static pairs, such as product availability, pricing, technological features, etc., may have changed in the intervening period of time. For example, one element of the parent-child or parent-children pairs may be withdrawn from marketing. As such, a customer may be taken along a parent-child or parent-children sales path that is no longer valid. In such an event, these paths of static pairs are often invalid due to a break(s) in the parent-child, or parent-children, linked pairs. Breaks in the linked parent-child pairs are undesirable as these breaks cause credibility and relevancy issues for the customer who may loose interest and not make a purchase.

For instance, when a customer enters a seller's market browsing or desiring to buy a particular product, the entry price point of such particular product is advertised and the customer may be brought along an up-sell path of a number of consecutively linked parent-child pairs until a targeted market ideal spot is reached (i.e., the point at which the seller would like the customer to purchase a product, such as, technology-price point). However, this up-sell path may be broken when one of the products within a parent-child pair is no longer available; when a sales price increases too dramatically from one pair to another; when a new parent-child pair added to the link has too large of a sales price increase or undesirable technological features; when there is a sudden promotional price reduction in one of the pairs that leads to a down-sell in one pair and too large of a price increase for the next consecutive pair; when the customer is an entitled customer (as defined below) that receives special price reductions from the seller and this reduction is not compatible with the static up-sell pairs; or even component life cycle depreciation. Typically, customers or business partners are sensitive to the price of a single up-sell tactic in that there is an upper threshold they will not cross on a single step. However, as long as value is perceived by the customer or business partner for each up-sell step, multiple steps may be taken resulting in a sale that may be three to five times the single step upper threshold. Another problem is that the price component is the list price, not the promotional or entitled price. For promotional pricing on the parent, the up-sell sales recommendation for the child or children could surpass the customer's price tolerance or upper threshold for a single step. For promotional pricing on the child, the up-sell sales recommendation could result in an alternative-sell or down-sell. Similar situations arise for customers or business partners with entitled pricing. Up-sell paths made up of a plurality of static parent-children links also suffer from the above problems.

Thus, once one of the static pairs has been broken, successive links in the chain would not be referenced. As a result, a sales recommendation that is viewed as not-credible might be displayed, which undesirably diminishes the value of the pairing recommendations to the customer, business partner or sales team. In the event of a break in the linked parent-child pairs, the conventional approach is to have a sales person recover the potential sale by reverting to the sales person's expert knowledge, or returning to the previous parent and manually locating an alternative child to recommend. Again, this type of disruption in the sales path can be disconcerting during a sales session or conversation, and may ultimately lead to the demise of a potential sale of a more richly configured solution that meets the customers' or business partner's needs.

Another prior art approach for up-selling, alternative-selling and down-selling includes the use of association matrices based on the two-dimensions of price and performance, typically on one element of the good or service offering. In this type of approach, a parent good or service resides within the matrix is surrounded by the up-sell, alternative-sell and down-sell children. A potential up-sell child(ren) resides above the parent within the matrix, the alternative-sell child(ren) resides to the right and left of the parent, and the down-sell child(ren) resides below the parent within the matrix. However, this approach suffers from several drawbacks within the parent-child(rent) matrix including, but not limited to, non-feasible recommendations due to price and/or performance differences being too dramatically changed for the specific customer; ignored goods or services within the matrix; goods or services within the matrix being of little or no value for either the customer, business partner or seller's sales staff; and price and performance ranges being arbitrary and static relative to each other. The use of matrices in providing sales recommendations are also undesirable since they are two-dimensional taking into account only price and performance, and not customer opinions, preferences, analytics and/or insight, nor the availability of goods or services.

Accordingly, further improvements are needed in providing sales recommendations to consumers that will avoid the problems associated with the prior art including, but not limited to, the unresolved issues of link breakage in the parent-child chain, the arbitrary and static nature of the pairs, the lack of tailoring the pairs to specific customer wants and needs, the requirement for experts to manually create and maintain the vitality of the pair structure, as well as the lack of integration of availability, price, performance and demand history to display relevant pairs.

### SUMMARY OF THE INVENTION

Bearing in mind the problems and deficiencies of the prior art, it is therefore an object of the present invention to provide methods, systems and program products for generating and providing dynamic, real-time sales recommendations based on current availability, price, performance and customer demand history information.

It is another object of the present invention to provide methods, systems and program products for providing dynamic, real-time sales recommendations that are based on current information tailored to a customer's wants and needs.

Another object of the invention is to provide methods, systems and program products for providing dynamic, real-time up-sell, alternative-sell, down-sell, or even combinations thereof, sales recommendations.

A further object of the invention is to provide methods, systems and program products for providing dynamic, real-time sales recommendations that substantially eliminate breakage in the parent-child(ren) sales chain.

It is yet another object of the present invention to provide methods, systems and program products for providing automated dynamic, real-time sales recommendations that are continually updated and tailored to current goods and/or services availability, price, performance, and customer and business partner data information.

Another object of the invention is to provide methods, systems and program products for providing dynamic, real-time sales recommendations that are based on availability, price, performance and consumer demand history.

Still another object of the invention is to provide methods, systems and program products for providing dynamic, real-time sales recommendations that increase sales and profitability, reduce inventory liability, ensure sale retention, and provide and retain customer loyalty and satisfaction.

A further object of the invention is to provide methods, systems and program products for providing dynamic, real-time sales recommendations that are reliable, rules driven, supply based and synchronized across all channels or routes to market.

Yet another object of the invention is to provide methods, systems and program products for providing dynamic, real-time sales recommendations that relate to a variety of fields including, but not limited to, demand management, finance, sales, marketing, merchandising, Internet operations, order management, procurement, manufacturing, and consultancy.

Still other objects and advantages of the invention will in part be obvious and will in part be apparent from the specification.

The above and other objects, which will be apparent to those skilled in art, are achieved in the present invention, which is directed to in a first aspect, a method for providing dynamic, real-time sales recommendations. The method first includes a user selecting a sales offering. Once a sales offering has been selected data feeds, which may be either batch data feeds and/or real-time data feeds, and the selected sales offering are transmitted to a real-time data interface. The real-time data interface then generates real-time sales recommendations using these selected sales offering and the data feeds. The user may be a customer, business partner, sales representative, or combinations thereof, while the sales offering may be a good and/or service.

In this aspect, the batch or real-time data feeds comprise a combination of currently available sales offering pricing, availability, performance and data-mined analytics information. The data-mined analytics information includes, but is not limited to, sales offering demand history, user demand history, firmographics, psychographics, place of purchase, company size, territories, industries, postal codes, user information, user input, user feedback, user buying behaviors and characteristics, and secondary buying characteristics.

The real-time data interface preferably generates the real-time sales recommendations by determining price-performance vector angles that define four distinct sell spaces that include an up-sell space, a down-sell space, a first alternative-sell space, and a second alternative-sell space. These real-time sales recommendations are generated for both simple price-performance relationships and complex price-performance relationships. The real-time sales recommendations may include up-sell, down-sell and alternative-sell recommendations, whereby business rules determine which of the four distinct sell spaces these real-time sales recommendations will occupy.

The method may further include tailoring the real-times sales recommendations in response to wants and needs of the user, as well as continually updating the data feeds using currently available sales offering information. Data structures are then refreshed using the data feeds, and the selected sales offering and the data structures are transmitted to the real-time data interface. A data model is a program design that is built and tested, and the data structures within the model are repopulated with new data contact or records. Once therein, the real-time sales recommendations are generated using such selected sales offering and the data structures. In so doing, this batch update step includes updating the sales offering pricing, availability, performance and data-mined analytics information, followed by transmitting such information to the real-time data interface for generating the real-time sales recommendations.

In the invention, the real-time data interface employs business rules for generating the real-time sales recommendations, whereby these business rules are used to provide the user with a select group of the real-time sales recommendations that meet the user's wants and needs. The real-time sales recommendations may fall within a single sales offering family, a plurality of similar sales offering families, a plurality of different sales offering families, or even combinations thereof. The method may further include initiating a request for a solution sales recommendation to satisfy the user's wants and needs, whereby at least two of the real-time sales recommendations, when combined together, comprise the solution sales recommendation.

In another aspect, the invention is directed to a system for providing dynamic, real-time sales recommendations that includes a pricing component, an availability component, a performance component, an analytics component, and a real-time data interface. The pricing component provides batch or real-time pricing information for a sales offering, while the availability component provides a netted supply available of such sales offering in batch or real-time updates. Also in batch or real-time updates, the performance component provides performance and capabilities data relating to the sales offering, and the analytics component provides data-mined analytics information. The real-time data interface then generates real-time sales recommendations based on the sales offering and the pricing information, the netted supply available, the performance and capabilities data, and the data-mined analytics information.

In still another aspect, the invention is directed to a program storage device readable by a processor capable of executing instructions, tangibly embodying a program of instructions executable by the processor to perform method steps for providing dynamic, real-time sales recommendations. The method steps include a user selecting a sales offering, transmitting data feeds to a real-time data interface, transmitting the selected sales offering to the real-time data interface, and then generating real-time sales recommendations within the real-time data interface using the selected sales offering and the data feeds.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a diagram illustrating the system architecture upon which real-time, on demand multiple sales recommendations are provided in accordance with the invention.

FIG. 2 is a process flow of the invention showing the preferred steps for providing real-time, on demand multiple sales recommendations.

FIG. 3 is a template of the invention illustrating the goods and services capabilities.

FIG. 4A is a template of the invention illustrating the goods and services cross references.

FIG. 4B is a diagram of the invention illustrating the overlap of several goods and services families within the goods and services cross references in relation to a selected good or service.

FIG. 5A is a template of the invention illustrating the goods and services to customer cross reference.

FIG. 5B is a diagram of the invention illustrating the goods and services to customer cross references whereby customer attribute templates are cross referenced with selected goods and services for the respective customers.

FIG. 6 is a template of the customer attributes of the invention showing a customer table populated with customer tier and analytics data.

FIGS. 7A-D are graphical representations of complex performance and price relationships showing bi-modal linear, bi-modal nonlinear, multi-modal nonlinear and exponential relationships, respectively.

FIG. 8A is a diagram of the invention illustrating the performance and price relationships in relation to the selected good or service.

FIG. 8B is a diagram of the invention showing the quadrants of FIG. 8A.

FIG. 9A is a diagram of the invention illustrating a real-time up-sell three-dimensional space as a partially solid cylinder in relation to the selected good or service.

FIG. 9B is a diagram of the invention showing the up-sell space of FIG. 9A having a number of real-time up-sell recommendations.

FIG. 10 is a template of the invention illustrating the Goods and Services' price matrix by customer.

FIG. 11 is a template of the invention illustrating the Goods and Services' availability matrix by customer tier.

FIG. 12 is a template illustrating the sell space determination template of the invention.

FIG. 13 illustrates templates of the invention showing the sell space priorities.

### DESCRIPTION OF THE PREFERRED EMBODIMENT(S)

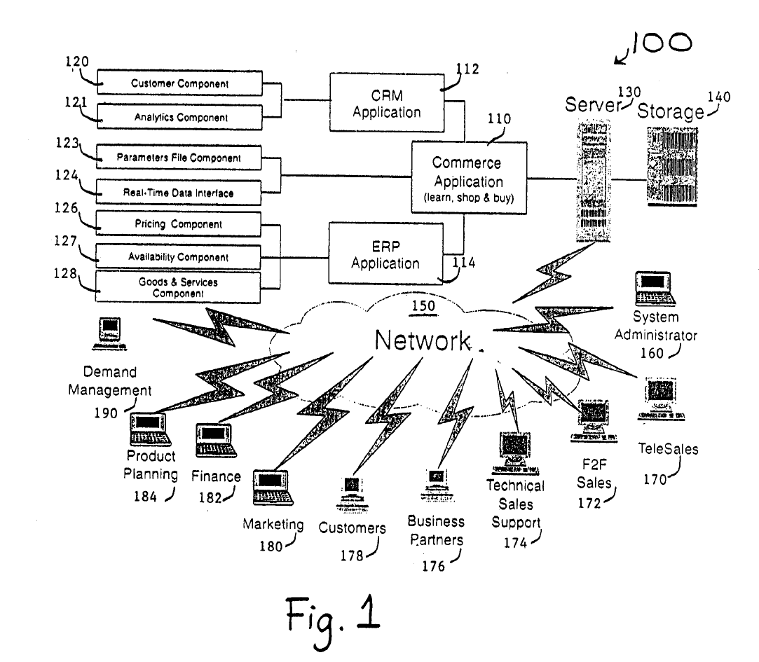

In describing the preferred embodiment of the present invention, reference will be made herein to FIGS. 1-13 of the drawings in which like numerals refer to like features of the invention.

Definitions relevant to the present invention are as follows:

User. A user of the invention may be a public customer, a registered customer or an entitled customer (hereinafter collectively referred to as “customer”) seeking to make a purchase; a business partner seeking to make a purchase and/or seller's sales staff assisting in the making of a purchase.

Public Customer. A public customer is a user who does not have a contractual relationship with the seller. These customers normally shop anonymously until they are prepared to buy. The public customer is unknown until the customer provides “ship to” and “payment” information to the seller (or registers on-line). Some general targeted merchandising tactics can be invoked during the learn and shop experiences based on analysis of the individual's or group's demand patterns and buying characteristics. Up-selling, alternative-selling or down-selling goods or services to public customers is possible based on performance, availability and price considerations.

Registered Customer. A registered customer is a user who does not have a contractual relationship with the seller, but has chosen to provide limited customer information to the seller. This customer receives value added offerings and incentives for registering and remaining registered (i.e., alerts, discounts, advance notifications, etc.). By identifying themselves, registered customers are better known to the seller and specific up-sell, alternative-sell, and down-sell merchandising tactics can be invoked based on customer segmentation or groupings. The seller maintains and updates the registered customers' profile for future sales based on recency, frequency, propensity to buy, commitment to the brand, share of the wallet, etc. Up-selling, alternative-selling or down-selling goods or services to registered customers is possible based on performance, availability and price considerations. Registered customers can view the same information as public customers, but receive additional benefits as described by the seller.

Entitled Customer. A customer is a consumer who has a special relationship with the seller, such as goods, services, availability, and pricing. Normally, this customer prefers a reduced version of the seller's catalog based on the contractual relationship between the customer and seller, specifically those goods and services that have pricing discounts and service level agreements. In some instances, the entitled customer is provided relationship pricing (i.e., a percentage reduction) on the remainder of the seller's catalog. The entitled customers are required to identify themselves during the learn, shop and buy experiences to view their contractual entitlements. The seller maintains and updates the entitled customer's profile for future sales based on recency, frequency, and share of the wallet. Up-selling, alternative-selling or down-selling goods or services to entitled customers are limited since entitled customers are tied to portfolio specifications due to maintenance, operability and management considerations. However, in select cases, the entitled customer may desired to browse the public catalog for unique goods or services (with relational pricing displayed), and there remains a possibility for up-selling, alternative-selling or down-selling goods or services based on performance, availability and price considerations.

Business Partner. A business partner is an intermediate sales conduit between the seller and a customer. The business partner enjoys a formal, contractual relationship with the seller, and sometimes the customer. The contractual relationship with the business partner includes discounted pricing, and other terms and conditions of mutual benefit. The business partner will normally provide some profile information that can be used in segmentation and analysis. Up-selling, alternative-selling or down-selling goods or services to business partners is possible based on performance, availability and price considerations. It is essential that the business partner obtain all of the essential information to close a sale, since business partners normally have other suppliers they can rely upon. The business partner has access to more information than a customer would see (i.e., netted available supply), but less than the seller' sales and marketing staffs. Examples of proprietary supplier and customer information that business partners may not be privy to are sources of supply, customer analytics, product cost information, etc.

Seller's Sales Staff. The seller's sales staff is comprised of the seller's face-to-face sales (e.g., staff to one customer or business partner, or an account representative with more than one customer or business partners), Technical Sales Support (i.e., service consultants, sales support, web services, etc.), and/or TeleSales Representatives. The seller's sales staff will conduct up-selling, alternative-selling and down-selling tactics, with or without customer segmentation or analytics. The seller's sales staff can view customer, business partner and seller's information completely based upon satisfactory log-in to a proprietary commerce application. In certain cases, a third party vendor may be selected and used to represent the seller, principally in selling and fulfilling goods and/or services. The seller-vendor relationship is not the same as the above business partner defined relationship in that the vendor would have full access to supplier and customer information.

Selected Goods or Services. The user selects a good or service during the learn (i.e., browse) and shop experience which is the basis for making a sales recommendation, which may be an up-sell recommendation, alternative-sell recommendation, down-sell recommendation, or combination thereof. The good or service selected may be an initial selection, or subsequent selections made during the current learn and shop experience. For example, a user may use multiple sales recommendations based on information provided during the learn or shop experience before entering the buy experience.

Goods. A manufactured tangible article that has economic utility, satisfies an economic need, or possesses intrinsic value (excluding financial instruments) that is available for monetary or other compensation.

Services. A useful labor or activity such as, for example, a warranty, post sales support, consulting, training, transportation, managed operations and the like. A service may be available for monetary or other compensation.

Learn. The user is browsing a catalog (e.g., an on-line catalog or a physical catalog) looking for suitable goods, services or options. In the case of goods or services, the user may be seeking a suitable starting point for the shop experience (i.e., configuration). The user should be prompted with potential up-sells, alternative-sells, down-sells, and cross-sells during this part of the purchasing experience. During the learn experience, the user may view the availability of the selectables, either in batch mode or real-time availability. If the good or service or option is satisfactory “as is,” the user goes straight from the learn step to the buy experience.

Shop. The user is customizing (configuring) a good or service based on selectables and options that are part of the offering. The user should be prompted with potential up-sells, alternative-sells, down-sells, and cross-sells during this part of the shopping experience.

Buy. The customer or business partner has made their selections from the learn and/or shop experiences, and is viewing the purchase list. The only additional merchandising opportunity is for cross-selling. To attempt up-sells, alternative-sells or down-sells during the buy experience would be counter-productive to closing the sale since the customer or business partner has made up their mind as to the product, price and availability. The only revenue opportunity is cross-selling.

Availability. Availability is expressed as a lead time in days (either to ship or arrival) based on the seller's scheduling application and business rules. The seller must use either “ship” or “arrival” consistently throughout the method. The selection of “ship” or “arrival” lead times is based upon seller's business practices and the scheduling application.

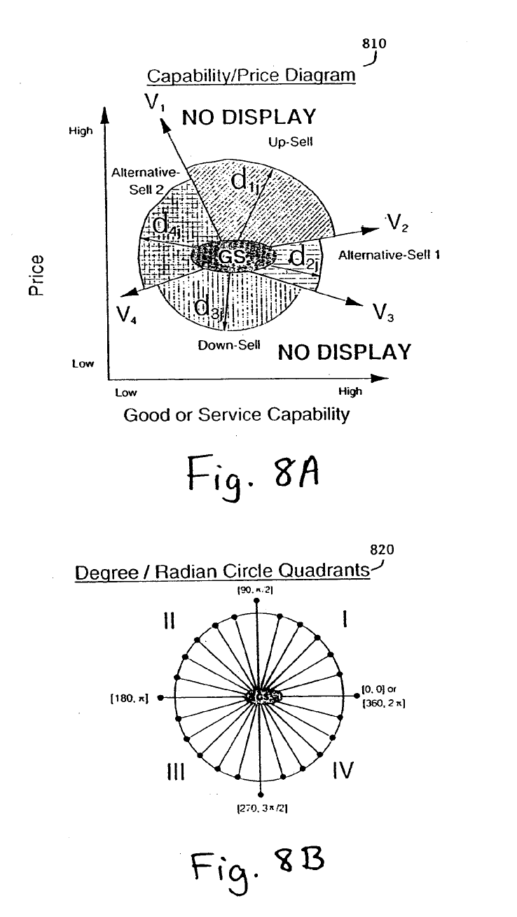

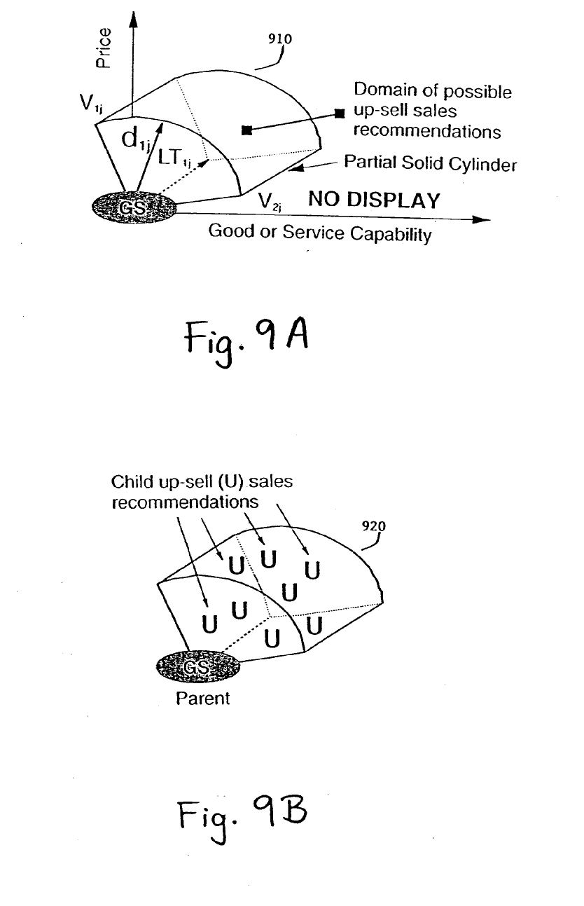

Up-sell. An up-sell opportunity is where a customer or business partner is sold a more richly-configured solution within the same good or service family above the customer's or business partner's initially selected price range that satisfies the availability requirement. Incentives may be used to entice customers to agree to an up-sell. An up-sell is above the good or service selected on the performance, price and availability partial cylindrical coordinate schema shown in FIGS. 8A, 8B, 9A and 9B. There will be a finite number of up-sell recommendations, preferably with substantially no up-sell recommendations for goods or services at the upper end of the price-performance curve, however, there may be instances where an insignificant amount of up-sell recommendations at such upper end may exist.

Alternative-sell. An alternative-sell relates to a sale of a similar good or service to the customer or business partner that falls within the selected price range and which satisfies the availability requirement. An alternative-sell is performed when an up-sell is not available and/or the customer or business partner opts for a similarly priced good or service. There are two alternative-sell spaces to the right and left of the good or service, which are selected based on performance, price and availability, as shown in the partial cylindrical coordinate schema of FIG. 8A. There will be a finite number of alternative-sell recommendations, preferably with substantially no defined alternative-sell recommendations for goods or services at the lower and upper ends of the price-performance curve, however, there may be instances where an insignificant amount of alternative-sell recommendations exist at the lower and upper ends of the price-performance curve.

Down-sell. A down-sell opportunity refers to a sale of a good or service that falls below the price range selected by the customer or business partner, and satisfies the availability requirement. A down-sell is preferably performed as a last resort, essentially to save the sale, when an up-sell or alternative-sell is not available, or the customer or business partner demands a lower-priced good or service. Referring to FIG. 8A, a down-sell is below the selected good or service on the performance, price and availability partial cylindrical coordinate schema. There will be a finite number of down-sell recommendations, preferably with substantially no defined down-sell recommendations for goods or services at the lower end of the price-performance curve, however, there may be instances where an insignificant amount of down-sell recommendations at the lower end may be needed to save the sale.

Cross-sell. A cross-sell opportunity provides complimentary goods and services based on the goods or services the customer or business partner has selected. Examples include shipping, warranty, accessories, or peripherals. Volume discounts may apply to cross-sell items.

Sell Space. There are four sell spaces that are smaller partially cylindrical subsets within the performance, price and availability three-dimensional domain. These spaces are defined by a starting point selected good or service (GSₛ)) for two left and right lateral limit vector angles (V) and price-performance arc (d) (distance from the starting point). See FIGS. 8A-B for representations of these relationships. Availability defines the center of rotation of the partially solid cylinder. See FIGS. 9A-B for illustrations of the up-sell space. The four factors of two price-performance vector angles (V), propensity to buy (d), and availability Lead Time (LT) calibrates the reasonability of the sales recommendations in relation to the selected good or service. These partially cylindrical spaces are (clockwise description from the top of the availability axis): Up-Sell Space (above good or service selected); Alternative-Sell 1 Space (right of good or service selected); Down-Sell Space (below good or service selected); and Alternative-Sell 2 Space (left of good or service selected).

Analytics. Analytics (i.e., data mining) is the conversion of data from multiple sources into actionable information. In making these conversions, analytics may apply statistical techniques and behavioral analyses with predictive modeling, scoring and data mining capabilities. The multiple sources used in determining analytics includes, but is not limited to, purchase history, buying behaviors, sales coverage, sales targeting, resource allocation, opportunity close rates, marketing queries, etc., with the goal of developing competitive prospect lists and selling point offerings or solutions to better fit customer wants and needs.

Propensity to Buy. Propensity to buy is the purchase behavior associated with identifiable customer or business partner characteristics and/or historical patterns. Propensity to buy models may include, for example, classification and/or predictive algorithms, estimated spend to company size, as well as demographic and/or economic information to determine future purchase behaviors and desired outcomes. Reliable propensity to buy models improves the successful conversion of individual sales transactions based on previous customer or business partner actions.

The present invention discloses methods, systems and program products for generating and providing dynamic, real-time sales recommendations based on up-to-date information. This sales recommendation invention overcomes the problems in the prior art by dynamically identifying, in real-time, the viable parent-child pairs, or alternatively parent-children pairs, for up-selling, alternative-selling and/or down-selling. These up-sell, alternative-sell and down-sell pairs are linked in real-time, and as such provide a valid chain of real-time sales recommendations that is continuously updated in real-time during the learning and/or shopping experiences. In so doing, demand conditioning initiatives may be used to facilitate these sales recommendations and close the sale. In providing sales recommendations in accordance with the invention, four essential criteria associated with the goods or services and/or with the customers or business partners are utilized including availability, performance (e.g., goods and/or services portfolios, technological features, etc.), price, and data mining (i.e., analytics).

Since customers and business partners typically have an expectation that sellers know them, their industries and/or sectors, data mining is an essential component of the invention. Data mining may include gathering and analyzing customer and business partner information that uses firmographics, psychographics and demographics including place of purchase (such as, country, territory, county, town, etc.), company size (revenue or employees), territories, industries, postal codes, historical demand data, as well as other marketing data analytics, and the like. Historical demand data can be extracted from several sources to include a seller's fulfillment systems, external vendor provided competitive files, or other pertinent databases. The historical data may be extracted from multiple customers, and/or applied to specific segments of a real-time sales recommendation portfolio or offering set. Alternatively, the historical demand data may be extracted and analyzed for a single customer or business partner to better tailor the real-time sales recommendations for that particular single customer or business partner.

Thus, the overall gathered data mining information is used to tailor a sales recommendation, or a set of sales recommendations, in response to a customer's or business partner's wants and needs. Dynamic data mining is essential since, in some instances, the time difference between when a first customer/business partner-to-seller contact occurs to a subsequent customer/business partner-to-seller contact occurs may be such that sales and supply information has changed. Thus, both the data-mined and supply-based (i.e., availability) information are preferably continually refreshed to provide up-to-date information relating to the customers and business partners, and for providing such customers and business partners with dynamic, real-time sales recommendations that will meet their desired wants and needs.

Thus, the present sales recommendation invention exploits goods or service portfolios, availability, pricing and data mining to drive and tailor up-sell, alternative-sell, and/or down-sell good and/or service sales recommendations. Marketing messages and merchandising tactics drive customer or business partner interest to the seller. Depending on the medium used to attract the customer or business partner, the time difference between campaign initiation and customer action may be such that supply chain support of the initiative may have changed. Accordingly, the seller needs to provide the customer or business partner with credible, real-time and on demand set of viable sales recommendations. While the customer or business partner is engaged, this customer's or business partner's buy decisions may be influenced via the seller's sales staffs, business partners or self-service on the Internet in accordance with the invention.

Accordingly, the present invention is advantageous since it provides the ability to conduct on demand up-selling, alternative-selling and down-selling that better integrate the supply chain horizontally, connecting the interaction of customers, business partners and the seller's sales teams (e.g., account representatives, service consultants, etc.) to the procurement and manufacturing capabilities of the seller, as well as to the wants and needs of the customers and business partners. In so doing, the customer, business partner, seller's sales staffs, and the supply chain advantageously support and manage each other, making the entity more responsive and accessible to the customers and business partners, and more effective and efficient for the seller. An essential feature is that the seller's sales staff does not have to back-track along one-to-many pair paths since there is no pair breakage within the dynamic real-time sales recommendations of the invention. The real-time sales recommendations reflect the changing parameters within the sales process (e.g., price, availability, goods and/or services performance, data mined information, etc.) by responding and adapting to the changing market conditions, availability, pricing and demand history.

The invention also advantageously enables sellers to provide an on demand business with business processes integrated end-to-end across the company and with business partners, suppliers and customers, such that the on demand business can respond flexibly and with speed to any customer demand, market opportunity or external threat. These types of on demand businesses are able to sense and respond to the changing market conditions; respond to new informational requirements instantaneously; concentrate on delivering value; and anticipate issues in real-time. The sales recommendation method drives efficiencies and ease of doing business for customers, business partners, and seller's sales staffs. The seller's sales staff or business partners can focus on increased sales face time with customers, which will advantageously lead to increased productivity for the seller. By providing responsive and suitable recommendations to customers, sellers are able to give their goods and/or services a competitive advantage over slower adversaries, as well as improve customer satisfaction. The use of availability information in accordance with the invention ensures improved demand and supply synchronization, and cycle time reductions. The on demand supply chain of the invention senses customer and business partner demands, and responds quickly to the changing market place with up-to-date, accurate sales information. To have the necessary agility in the market place, processes and applications must be supported with a robust set of business rules, with sense and respond technologies and techniques, and with a management system that spans the demand conditioning phases of planning, development and execution.

Another feature of the invention is that the real-time sales recommendations may be used for a variety of goods and/or services portfolios, and becomes an imperative as the size of the offering set grows, such as wherein the permutations within the portfolios is a function of 10^{x}, wherein x=2 or greater. For instance, when the goods and/or services portfolios has a sales offering set size of about 10⁴ or greater, the task of locating a substantially small subset of sales offerings within this larger set that is targeted to meet the customer's or business partner's wants and needs using conventional sales recommendation approaches is difficult and burdensome. However, the present real-time sales recommendation methods, systems and program products makes this task easier and more efficient by utilizing in combination current information relating to the sales price, goods and/or services availability, goods and/or services performance and features, and data mined information including, but not limited to, customer feedback and information, demand history, secondary buying characteristics such as color, brand, form, etc., to provide the dynamic, real-time up-sell, alternative-sell, down-sell, or combinations thereof, sales recommendations.

Referring to the invention, FIG. 1 shows a network system 100 for implementing the present sales recommendation invention. System 100 includes a host system or server executing Commerce Application (CA) 110, Customer Relationship Management (CRM) Application 112 and Enterprise Resource Planning (ERP) Application 114 running on a server 130 having storage 140.

The Commerce Application 110 integrates several components within the Customer Relationship Management 112 and Enterprise Resource Planning 114 applications. In particular, the Customer Relationship Management application includes Customer (C) 120 and Analytics (AN) 121 components, while the Enterprise Resource Planning application 114 includes Pricing (PR) 126, Availability (AV) 127, and Goods and Services (GS) 128 components. The Commerce Application 110 includes a Parameters File (PF) component 123 and Real-Time Data Interface (RTDI) 124. In accordance with the invention, the Parameters File 123 provides rapid change control without resorting to reprogramming. The Customer 120, Analytics 121, Pricing 126, Availability 127 and Goods and Services 128 components provide batch or real-time data feeds to the Real-Time Data Interface 124.

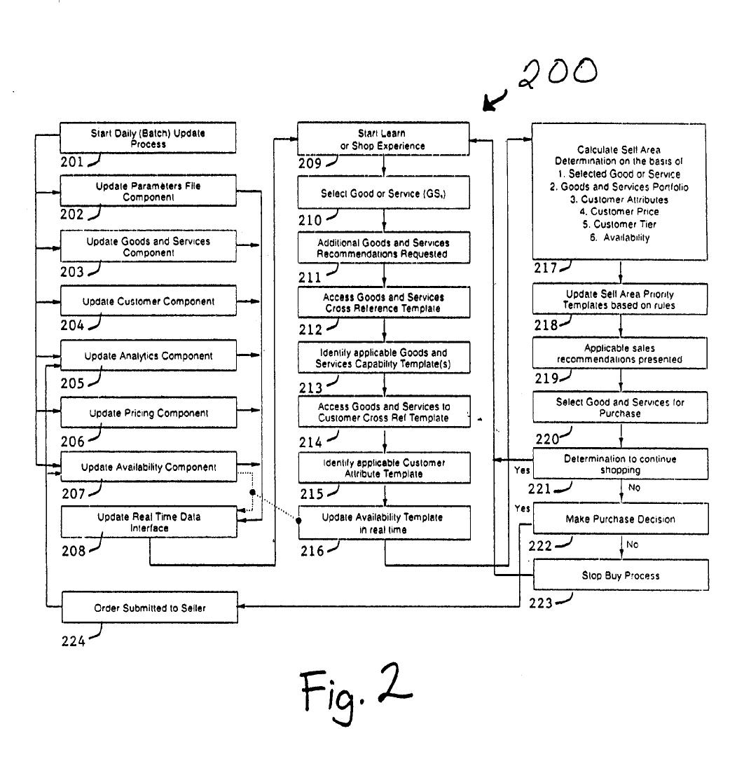

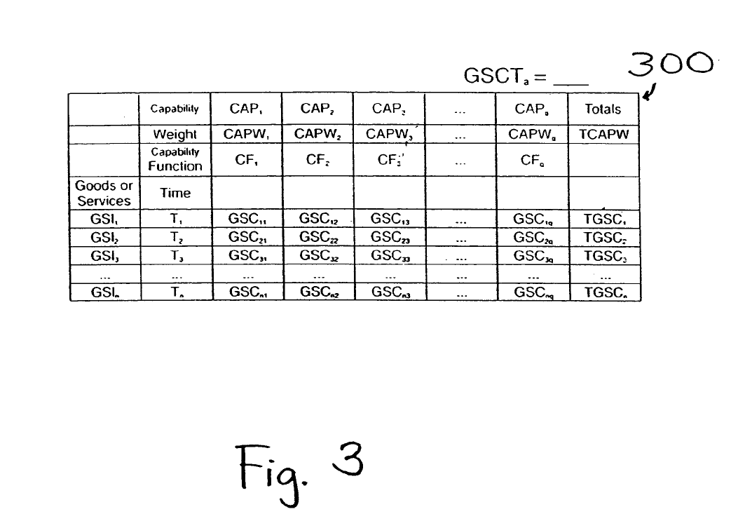

FIG. 2 shows the preferred process steps of the invention occurring within the Real-Time Data Interface 124 using the data structures shown in FIGS. 3-13 and mathematical calculations used therein. The Real-Time Data Interface 124 is an essential component of the invention since it generates the multiple up-sell, alternative-sell, and down-sell pairs in real-time and on demand, and transmits the same to the Commerce Application 110 for the learn, shop and buy experiences. For purposes of illustration, the non-web components could utilize IBM's Lotus 1-2-3 spreadsheets, DB/2 databases, WebSphere middleware, or other suitable, commercially-available data-intense manipulation programs depending on the scope of implementation.

Referring to FIG. 1 of the invention, the Customer component 120 contains a list of all types of customers (i.e., public, registered and entitled customers) and business partners, as well as their respective contact information, billing address, sector, industry, log-in permissions, and the like. This Customer component is based on input requests (add, change or delete) from TeleSales 170, Face-to-Face (F2F) Sales 172, Technical Sales Support 174, Business Partners 176 and Customers 178.

The Analytics component 121 builds data structures that analyze customer and business partner demand history to determine their propensity to buy, share of the wallet, sales opportunities, internal data including, for example, history, employee size and annual sales, as well as other key measurements that are converted into customer attributes. The analytics component is updated dynamically in real-time, or on a periodic basis, whereby as the data structures are refreshed and changed, this new, up-to-date information is transmitted to the Real-Time Data Interface. In so doing, these data structures may be updated based on the continually changing market parameters including, but not limited to, price performance sensitivity analysis, demand patterns, availability considerations, market positioning and the like. Wherein the Analytics Component 121 is routinely updated, this update information is preferably maintained by Marketing 180.

An essential feature is that both the Customer Component 120 information and the Analytics Component 121 information are transmitted to the Real-Time Data Interface 124 of the invention via the Customer Relationship Management 112 and Commerce 110 applications for generating the updated real-time sales recommendations of the invention. The Parameters File component 123 manages the Commerce application 110 and the Real-Time Data Interface 124 by maintaining the seller's business rules and other application variables, which is advantageous since resorting to major programming changes is avoided. Marketing 180 manages the Parameters File component 123.

The Real-Time Data Interface 124 contains various data templates and associated mathematical treatments used within the sales recommendation method on the basis of data provided by the Customer 120, Analytics 121, Pricing 126, Availability 127, and Goods and Services 128 components and driven by business rules and programming codes contained in the Parameters File component 123. For those skilled in the art, the Real-Time Data Interface may be employed as a callable service within a Systems Oriented Architecture (SOA) which allows the Interface to be reused within the entity without significant reprogramming. Marketing 180 is responsible for the maintenance and operation of the Real-Time Data Interface in conjunction with the System Administrator 160.

The Pricing component 126 is updated based on list price displayed to public and registered customers, relationship prices to business partners and entitled customers, delegated pricing to seller's sales staffs, and discounted pricing with entitled customers. Preferably, delegated pricing is not used; however, it does provide the seller's sales staffs with an incentive to close the sale during the Buy experience. The Pricing component information is provided to the Real-Time Data Interface 124 via the Enterprise Resource Planning 114 and Commerce 110 applications. Finance 182 maintains the Pricing component.

The Availability component 127 is updated from the scheduling application on a periodic basis based on the netted supply and associated business rules i.e., customer tiering, allocations, brokering schema, etc. The availability statement will follow the rules of scheduling and will be expressed as lead time in days or weeks, either lead-time-to-ship or lead-time-to-arrival. The Availability component can be updated on a batch basis (one or more times per day) or in real-time. Customers and business partners are assigned to tiers retained in the Customer component 120 and Real-Time Data Interface 124. The Availability component information is provided to the Real-Time Data Interface 124 via the Enterprise Resource Planning application 114 and Commerce application 110. Demand Management 190 maintains the Availability component.

The Goods and Services component 128 is the seller's goods and services portfolio, preferably in electronic format. It contains the key elements of the offering (e.g., technical specifications, association rules for valid configuration, announce and withdrawal dates, etc.) that are subject to Capability Function calculations. The Goods and Services component information is provided to the Real-Time Data Interface 124 via the Enterprise Resource Planning 114 and Commerce 110 applications. This Goods and Services component is maintained by Product Planning 184, in close cooperation with Marketing 180 and Finance 182.

The server 130 includes or is connected to a storage 140 component, as well as to a plurality of client systems 160-190 through a Network 150. The server 130 may include one of more servers operating in response to a computer program stored in a storage medium accessible by such servers. The server 130 preferably operates through a network server (e.g., a web server) to communicate with the client systems 160-190, whereby the server 130 sends and receives information to and from the client systems 160-190, and performs associated tasks. In so doing, the server 130 is capable of executing various applications typically found in a business entity.

The server 130 may also operate as an application server, whereby it executes one or more computer programs to implement the present sales recommendation system processes and related functions. As previously described, it is understood that separate servers may be utilized to implement the network server functions and the application server functions. Alternatively, the network server, the firewall, and the application server may be implemented by a single server executing computer programs to perform the requisite functions.

For example, the server 130 may include, but is not limited to, an IBM® eServer (iSeries™, pSeries™, xSeries™ or zSeries™) or any other commercially-available computer system suitable for the scope of implementation in accordance with the invention. The Server may execute web server software designed to accommodate various forms of communications, including voice, video, and text typically utilized by large business enterprises. Any web server software or similar program that handles general communications protocols and transport layer activities could be used as appropriate for the network protocol in use. For instance, the server may run IBM's Lotus Domino™ and Lotus Notes™ as its groupware applications software; however, any compatible e-mail-integrated, web-enabled collaborative software could be used.

The storage system 140 may be implemented using a variety of devices known for storing electronic information. It should be understood that the storage device 140 may be implemented using memory contained in the server 130, or alternatively, it may be a separate physical device. The storage device 140 is logically addressable as a consolidated data source across a distributed environment that includes a network 150. Information stored in the storage device 140 may be retrieved and manipulated via the server 130 by a database manager and data mining software. For purposes of illustration, the database manager may be IBM's DB/2 software. The storage device 140 includes a data repository containing documents, data, web pages, images, multimedia, etc. Further, storage device 140 stores configuration files (also referred to herein as page tokens). In an exemplary embodiment, the server 130 operates as a database server and coordinates access to application data including data stored within the storage device 140.

The storage system 140 comprises any form of mass storage device configured to read and write database-type data maintained in a file store (e.g., a magnetic disk data storage device). The storage device can range from a single Hard Disk Drive on a personal computer to large enterprise storage systems, i.e., IBM's Shark™. Of course, it should be understood that the storage device may be one that consists of multiple disk subsystems which may be geographically dispersed and coupled via network architecture. The implementation of local and wide-area database management systems to achieve the functionality of the storage device will be readily understood by those skilled in the art.

Network 150 may be any type of known network including, but not limited to, a Local Area Network (LAN), a Wide Area Network (WAN), a global network (e.g., Internet), a Virtual Private Network (VPN), an intranet, or other network configuration known in the art. These networks may be implemented using a wireless network or physically connected to each other in a state of the art configuration. One or more of the client systems 160-190 may be coupled to the server 130 through multiple networks (e.g., intranet and Internet) so that not all clients systems 160-190 are coupled to server 130 through the same network. One or more of the client systems 160-190 and the server 130 may be connected to the network 150 in a wireless fashion. For example, one or more client systems 160-190 may execute a user interface application (e.g., a web browser) to contact the server 130 through the network 150, while another client system is directly connected to the server 130. Also, client system is connected directly (i.e., not through the network 150) to the server 130 and the server is connected directly to or contains the storage device 140. Further, the network may include wireless connections, radio based communications, telephone based communications, and other network-based communications. Secure Socket Layer (SSL encryption) software may be used to control access to server system, limiting permissions to network users, such as remote client systems or vendor systems, who have proper authorization.

Client systems 160-190 comprise known computer devices that allow systems to connect to the network and server. Client systems may access the server via a seller's web browsers. Individual client systems are described below, and may include suitable computer systems. Individuals and teams involved in the selling, marketing and merchandising goods or services perform specific roles throughout the described process. They are also in communication with each other via client systems as will be described further herein.

System Administrator 160 refers to a client system operated to manage the performance, operation, and maintenance of the server system, storage system and networks identified in the foregoing discussion. The System Administrator manages the Server 130, Storage 140, and Network 150 and applicable applications and components is close coordination with the specified owners.

TeleSales 170 assists customers and business partners during the learn, shop and buy experiences, provides sales recommendations, and enters customer orders via the telephone for goods or services into the Commerce application based on data from the Pricing 126, Availability 127 and Goods and Services 128 components. In some cases, where TeleSales support entitled customers or business partners, there is a contractual relationship specifying goods, services, and prices. Additionally, the contract may dictate service level agreements and higher customer tiers to drive improved availability. These orders are entered into the Commerce Application 110 and the Enterprise Resource Planning application 114, thereby updating the Availability 127 and Analytics 121 components. As required, the customer information in the Customer component 120 is updated, whereby this customer information includes, but not limited to, any change in customer tier, billing address, customer identity information, and the like.

Face-to-Face Sales 172 assists customers during the learn, shop and buy experiences, provides sales recommendations, and enters customer orders based on signed contracts for goods or services into the Commerce application based on data from the Pricing 126, Availability 127 and Goods and Services 128 components. In most cases, there is a contractual relationship specifying goods, services and prices. Additionally, the contract may dictate service level agreements and higher customer tiers to drive improved availability. These orders are entered into the Commerce 110 and Enterprise Resource Planning 114 applications, thereby updating the Availability 127 and Analytics 121 components. As required, the Customer component 120 information is updated.

Technical Sales Support 174 assists customers and business partners during the parts of the learn, shop and buy experiences, provides limited sales recommendations, and enters or updates customer orders via the telephone, mail, FAX, web transactions or other electronic data interfaces for goods or services into the Commerce application based on data from the Pricing 126, Availability 127 and Goods and Services 128 components. These orders are entered into the Commerce 110 and Enterprise Resource Planning 114 applications, thereby updating the Availability 127 and Analytics 121 components. Technical Sales Support 174 interacts with TeleSales 170, Face-to-Face Sales 172, Business Partners 176 and Customers 178 and provides technical assistance such as configuration development, technical specifications, additional services, warranty coverage, etc. Customer component 120 information is updated as required.

Business Partner 176 assists customers during the learn, shop and buy experiences, provides sales recommendations, and enters customer orders via the web or telephone based on signed contracts for goods or services into the Commerce application based on data from the Pricing 126, Availability 127 and Goods and Services 128 components. In most cases, there is a contractual relationship specifying discounted prices and sales price limitations. Additionally, the contract may dictate service level agreements and higher customer tiers to drive improved availability. These orders are entered into the Commerce 110 and ERP 114 applications, thereby updating the Availability 127 and Analytics 121 components. Customer component 120 information is updated, as required, to include information on the business partner.

Customers 178 navigate through part or all of the learn, shop and buy experiences, and request additional information which may result in sales recommendations. The customers directly enter their orders via the web or telephone for goods or services into the Commerce application based on data from the Pricing 126, Availability 127 and Goods and Services 128 components. These orders are entered into the Commerce 110 and ERP 114 applications, thereby updating the Availability 127 and Analytics 121 components. Customer component 120 information is updated as required.

Marketing 180 uses the Customer Relationship Management (CRM) application 112 to generate demand with the customers identified within the CRM application. The CRM application is used to pass the opportunities to the various sales channels. Marketing 180 identifies solution (goods and services) concepts in coordination with Finance 182, Product Planning 184 and Demand Management 190. As a result of these collaborative efforts, the Parameters File 123, Pricing 126, and Goods and Services 128 components are created and maintained on a scheduled basis. Marketing is responsible for the management of the Parameters File 123 and Real-Time Data Interface 124. Marketing develops and refines different types of analytic models (i.e., propensity to buy, account reactivation, brand loyalty, share of the wallet, risk, etc.) used within the analytics 121 component. These analytic structures determine the sell spaces within the method (right and left limits and magnitude) based on customer type (registered or entitled) and/or market segment.

Finance 182 coordinates with Marketing 180 and Product Planning 184 for the management of the Pricing 126 component. Finance is responsible for setting and assigning revenue targets. Finance manages the Pricing component on many marketplace factors to include feedback from TeleSales 170, Face-to-Face Sales 172, Marketing 180 and Demand Management 190.

Product Planning 184 coordinates with Marketing 180 and Finance 182 for the management of the Goods and Services 128 component. Product Planning assists Marketing and Finance in establishing the initial list price. Product planning develops goods and services that meet business requirements specified by Marketing and revenue objectives levied by Finance.

Demand Management 190 manages the Availability 127 component. Demand Management 190 coordinates with Marketing 180 and Finance 182 the balancing of forecasted demand and committed supply. The scheduling function within the ERP application balances demand and supply based on business rules and produces the availability statement. Demand Management determines business rules for scheduling production of goods and delivery of services, and coordinates with TeleSales 170, Face-to-Face Sales 172, and Marketing 180 on customer tiering, which is part of the Parameters File.

Referring now to FIG. 2, a process flow 200 of the invention is shown for generating and providing dynamic, real-time sales recommendations based on up-to-date information, whereby these sales recommendations may be up-sell, alternative-sell or down sell recommendations, or even combinations thereof. The process flow begins at step 201 wherein at least once daily a batch update is performed whereby template data tables within the Real-Time Data Interface 124 are updated. For highly dynamic systems, the template data tables within the Real-Time Data Interface 124 are updated continuously in real-time based on current information or the frequency of the batch updates are increased.

The batch update process includes dynamically updating the information within the Parameters File 123 (step 202), Goods and Services 128 (step 203), Customer 120 (step 204), Analytics 121 (step 205), Pricing 126 (step 206) and Availability 127 (step 207) components, and transmitting such updated information to the Real-Time Data Interface 124 (step 208) through the Commerce Application, Customer Relationship Management and Enterprise Resource Planning components of the invention. This batch update is particularly useful for selected data templates having increased daily changes such as, for example, pricing, availability, etc.

In step 202, the Parameters File 123 has its business rules and processing codes routinely updated to reflect any changed business rules and/or processing codes, thereby accommodating for dynamic business conditions without any software reprogramming. Refreshing table structures with new data contents or records eliminates software testing. In so doing, the Parameters File advantageously provides control and direction pertaining to the present method, particularly in determining which sales recommendations should be presented to the seller's sales staff, customer or business partner. These updated business rules and processing codes within the Parameters File 123 are transmitted to the various applications and components as required. All of the Capability Functions (CF) are maintained within the Parameters File.

In step 203, the Goods and Services 128 are continually, dynamically updated to reflect newly added and/or revised offering information such as, for example, announcements, withdrawals, new sales products, etc. on at least a daily basis. This Goods and Services update information is transmitted to the Real-time Data Interface 124 through the Enterprise Resource Planning Application 114.

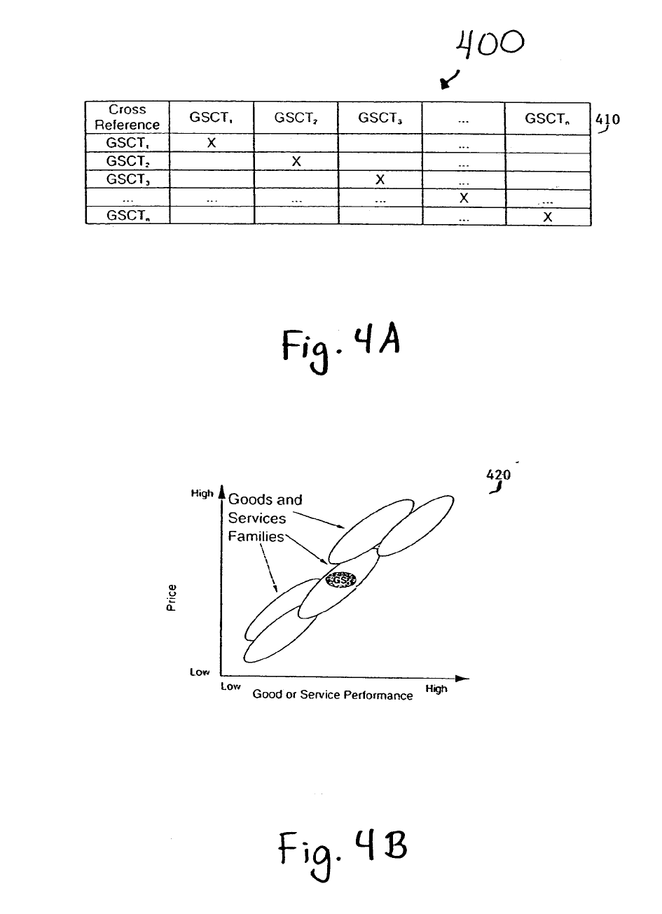

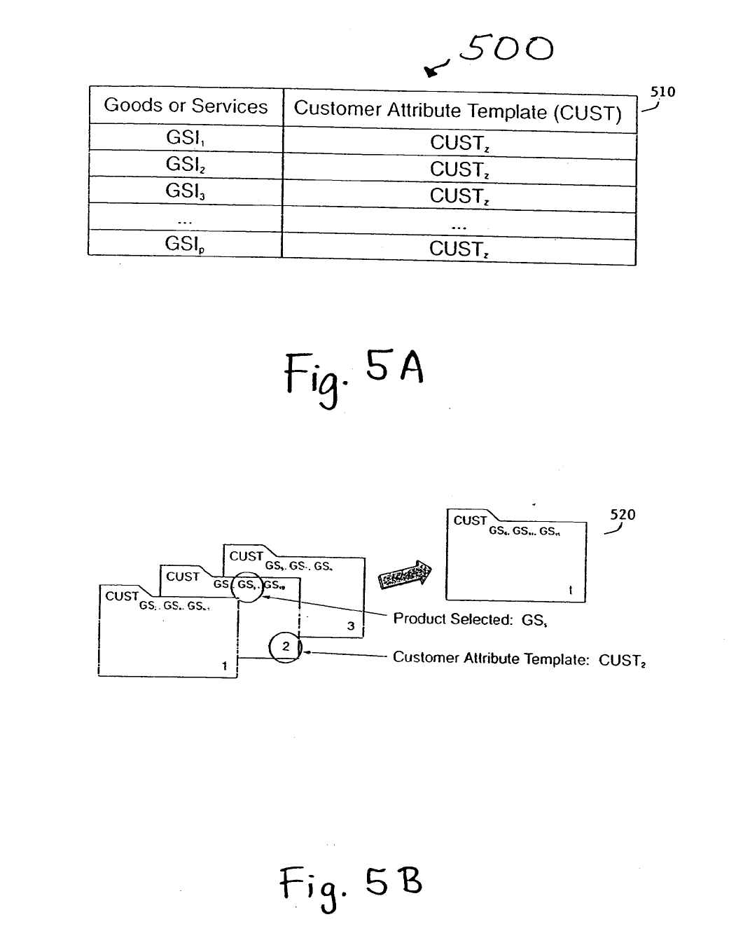

Referring to FIGS. 3-6, once the Goods and Services update information has been transmitted to the Real-time Data Interface 124, the Goods and Services Capabilities Template 300 (FIG. 3), Goods and Services Cross Reference Template 400 (FIG. 4A) and the Goods and Services to Customer Cross Reference Template 500 (FIG. 5A) are all updated in the Real-Time Data Interface at step 208. In so doing, on at least a daily basis, the Goods and Services Capabilities Template 300 has its capabilities (CAP), capability weights (CAPW), total capability weight (TCAPW), and capability functions (CF) refreshed and updated.

As illustrated in FIG. 3, there will be one Goods and Services Capability Template for each family of goods or services. There may be more than one family of goods and services, up to a quantity of “m.” Therefore, the Goods and Services Capability Template (GSCTₐ) identifies one family of goods and services, whereby a=1 to m. Goods and Services Items (GSIₖ) are the elements contained in a family of goods and services, whereby k=1 to n and “n” may vary by specific family template. The Capability Attributes (CAPᵢ) are the unique, but common set of attributes for a specific family of goods and services, whereby i=1 to q and “q” may vary by specific family template. The Goods and Services Items (GSIₖ) and Capability Attributes (CAPᵢ) are the two major dimensions of template 300.

Each goods and services capability attribute is weighted (CAPWᵢ). Total Capability Weight or TCAPW=[Sum of CAPWᵢ], where TCAPW does not have to equal 100. Time (Tₖ) is the age of good or service GSIₖ (elapsed time since announcement). Capability Function (CFᵢ) may be a constant, decay curve, linear relationship, step equation, or other form of distribution from the Parameters File component 123. For each good or service capability attribute (CAPᵢ) and Goods and Services Items (GSIₖ), a capability score (GSCᵢₖ) is calculated as a function of time (CFᵢ(Tₖ)), whereby i=1 to q and k =1 to n. Total Goods and Services Capability, or TGSCₖ=[Sum of {GSCₖᵢ×CAPWᵢ}]/TCAPW.

The Total Goods and Services Capability (TGSC) is the first of two elements in determining the origin of the price-performance vector angles within the present invention. For highly commoditized products having technical improvements as part of the continuous business cycle, the TGSC scores would expect to decline with time unless the marketplace is constrained.

It is preferred that the Total Goods and Services Capability (TGSC) calculations have a similar magnitude to the good's or service's price. The absolute value of TGSC minus price divided by the price provides a percentage for measuring the magnitude of similarity. There is no expectation that the percentage will be at or near zero percent. A percentage less than 20 percent is viewed as optimal. A high percentage indicates a significant difference between capability and price, which, in some instances, may be explained by a nonlinear capability-price relationship. As such, it is preferred within the present invention that the magnitude TGSC scores and price be substantially similar since a TGSC score significantly greater than price (for linear capability-price relationships) may lead to suitable alternative-sell sales recommendations being excluded. This could be an indicator of steep discounting due to marketplace conditions. Similarly, if the TGSC score is significantly less than price (for linear capability-price relationships), some appropriate up-sell and down-sell sales recommendations may be excluded. This situation could arise due to pricing not matching technological decline. As such, an entity implementing the present invention can provide enhanced business guidance in the form of a percentage threshold to Marketing.

Referring to FIG. 4A, the Goods and Services Cross Reference Template 410 is also updated in the Real-Time Data Interface in step 208. This Goods and Services Cross Reference Template, which is represented as (GSCTₐ), whereby a=1 to m (one template for each family of goods and services), is used to identify families of Goods and Services that are similar and have a degree of common function even though the capabilities, weights, time functions and product life cycles are different. This template permits multiple goods and services families to be considered for up-sell, alternative-sell, and down-sell pair opportunities, thereby advantageously providing sellers with additional opportunities to satisfy marketplace needs across goods and services portfolios.

The Total Goods and Services Capability (TGSC) scores that are of similar magnitude for a portion of the overlapping goods and services portfolios, even though the capabilities, weights, time functions and product life cycles may be different, is essential for updating the Goods and Services Cross Reference Template (GSCT) 410. Relationships between two product families may be indicated using a flag in the template (e.g., “X” or blank, “Y” or “N”, “1” or “0”) to connect two Goods and Services Capability Templates 300 together when creating appropriate up-sell, alternative-sell or down-sell recommendations, or even combinations thereof. For instance, FIG. 4A makes use of an “X” within template 410 to show the relationships between Goods and Services Capability Templates (GSCT). These relationships are further demonstrated in FIG. 4B showing the overlap of several goods and services families within a goods and services portfolio in relation to the selected good or service. For example, high-end Intel-based servers will have some overlap with low-end UNIX-based servers, and high-end UNIX-based servers will have comparable capabilities with low-end mainframe computers.

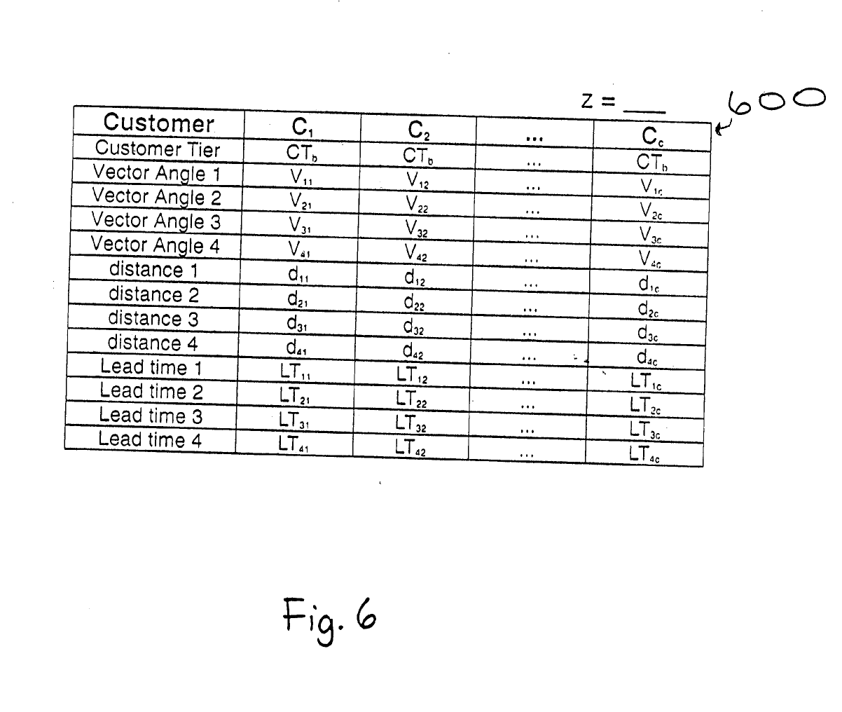

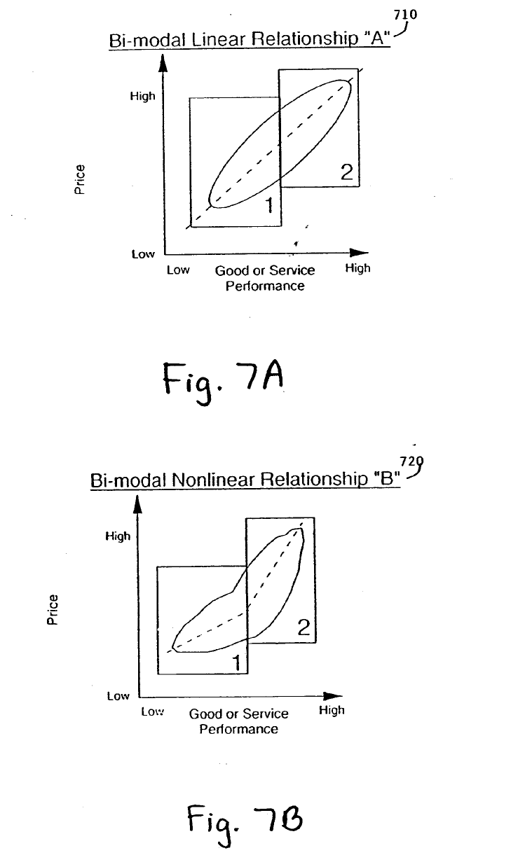

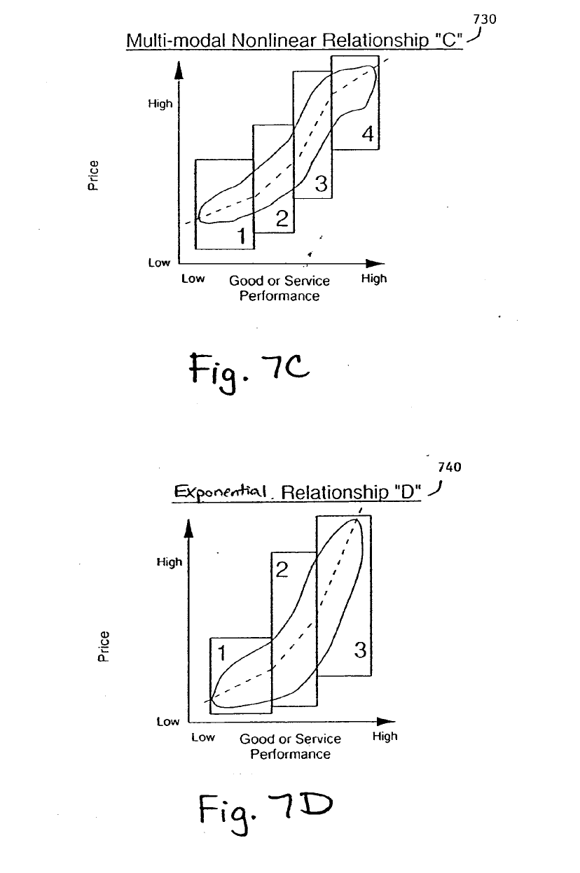

FIGS. 5A-B refers to product families having internal segmentation, showing various Goods and Services to Customer Cross Reference Templates for each goods or services portfolio. Wherein the goods or services portfolios (i.e., price-capability relationships) are simple uni-modal and linear portfolios, one Customer Attribute Template 600 exists, as shown in FIG. 6. However, wherein the goods or services portfolios (i.e., price-capability relationships) are complex bimodal, multi-modal, nonlinear or exponential portfolios, such as the relationship diagrams shown in FIGS. 7A-D, two or more Customer Attribute Templates may have their associations identified, such as that shown in the Goods and Services to Customer Cross-Reference Template 510 of FIG. 5A. In this aspect, the Goods and Services to Customer Cross-Reference Template 510 must be updated with Goods and Services portfolio (e.g., seller's catalog) information, whereby this data is cross referenced to a specific Customer Attribute Template (CUST) in the Real-Time Data Interface in step 208.

For simple good or service portfolios, the performance and price relationships are generally linear in nature and the buying characteristics are generally uniform. See FIGS. 7A-D for four complex performance and price relationship graphical examples. The performance and price relationship may be linear but the buying characteristics may be bi-modal i.e., the customer is more amenable to a more expensive up-sell price as the slope of the price-performance (technology) curve increases. As the relationships become nonlinear (shifts in performance within the portfolio i.e., processors, etc.), they can be viewed as bi-modal diagrams (710 and 720) or multi-modal diagram 730. Exponential diagram 740 (high end non-consumer goods i.e., mainframe computers, etc.) is germane to goods or services that have large price ranges. The method's flexibility permits multiple customer attribute templates (based on analytics) for specified segments of the portfolio.

Within the Goods and Services to Customer Cross-Reference Template 510, the Goods and Services Item is referred to as (GSIᵤ), whereby u=1 to p, whereby p is the total of all goods and services from all Goods and Services Capability Templates (GSCTₐ), whereby a=1 to m. The Selected Good or Service is referred to as (GSₛ), whereby y=s (the number of the good or service selected by the customer, business partner or internal sales staff during the learn or shop experience). Customer Attribute Table is referred to as (CUST_{z}), whereby z=1 to t, whereby “t” is the number of tables based on the complexity of the product portfolio.

Again, for simple product performance and price relationships, only one table may be needed (i.e., t=1), as shown in FIG. 6. However, as the complexity of the offering increases, additional tables may be required based on the complex bimodal, multi-modal, nonlinear or exponential changes in the product performance and price relationships, such as that shown in FIG. 5A. Diagram 520 of FIG. 5B illustrates the Selected Good or Service (GS,) is found in Customer Attribute Template #2. Customer Attribute Template #2 is used for illustrative purposes and contains those unique Vector Angles (V), distances (d) and Lead Times (LT) for that customer, customer set, or customer segment.

The batch update process continues in step 204 by updating the Customer 120 component of the invention. FIG. 6 illustrates the Customer Attribute Template 600. In accordance with the invention, there may be more than one Customer Attribute Template (CUST_{z}), whereby z=1 to t, whereby “t” is the number of templates for the product and service portfolio. The Customer Attribute Template may be manually initialized. However, once initialized, it is updated on a daily basis based on models from the Analytics 121 component of the invention. In so doing, the Customer Attribute Template 600 is updated with customer identifier (i.e. Cⱼ) and customer tier (CT_{b}) information in the Real-Time Data Interface, whereby this information is supplied to the Real-Time Data Interface through the Customer Relationship Management (CRM) Application 112 and the Commerce Application 110.

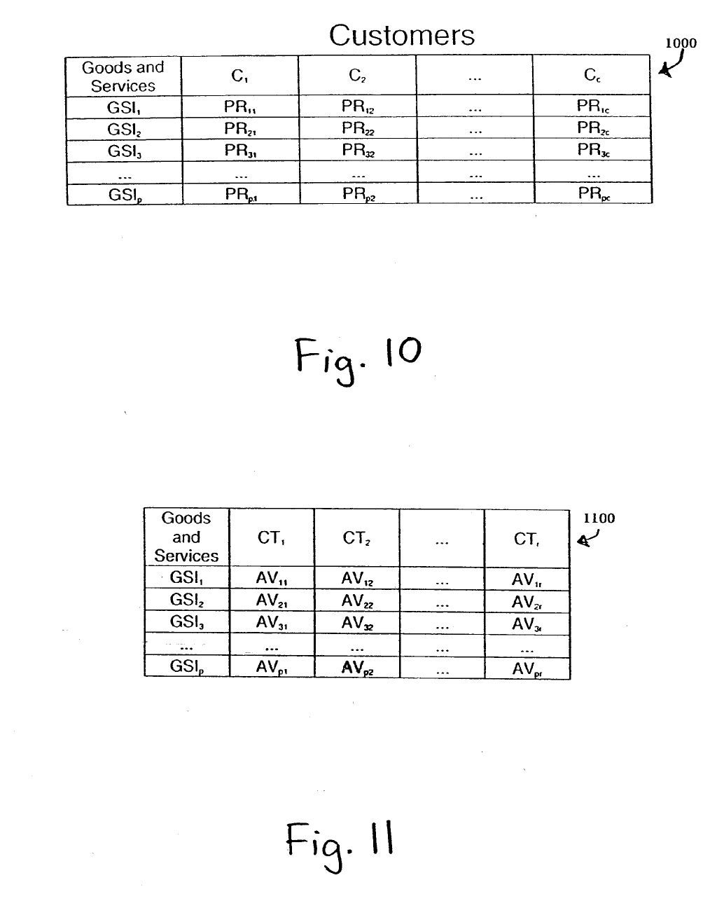

In the Customer Attribute Template 600 of FIG. 6, C₁ is designated as a public customer (anonymous shopper), and C₂ through C_{c} are registered customers, entitled customers and business partners. Customers are segmented by their profiles or demand patterns. Customer tier information is split via integer increments and assigned based on company criteria. Customer tiers are established to determine the allocation of supply and associated brokering rules, which drive the scheduling of orders and a specific availability message to each customer tier (see FIG. 11). Customer Tier is referred to as (CT_{b}), whereby b=1 to r in integer increments and assigned based on company criteria, where “r” is the total number of customer tiers.

An essential feature of the invention is that depending on the Selected Good or Service (GSₛ), the present real-time sales recommendation determines which Customer Attribute Template 600 to select for enabling the user to identify and use additional product families. In so doing, the invention advantageously provides a user with the broadest set of goods and services sales recommendations offered by the seller (see FIGS. 3, 4A and 4B), and with real-time sales recommendations that are based on the goods and services portfolio and customer insight such that these real-time sales recommendations are personalized to the specific buyer (see FIGS. 5A, 5B and 6).

The Customer Attribute Template 600 is also updated in the Real-Time Data Interface in step 208 using customer specific information derived from one or more models supplied from the Analytics 121 component in step 205. Again, the Analytics component 121 uses data structures based on specific business criteria (e.g., from order history or competitive data), and on analyzed customer and business partner demand history to determine their propensity to buy, share of the wallet, sales opportunities, internal data including, for example, history, employee size and annual sales, as well as other key measurements that are converted into customer attributes. These models may evolve over time as more data is obtained, more pertinent relationships are found, or marketplace trends change. As such, the analytics component is updated at least daily, or on a periodic basis, whereby as the data structures are refreshed and changed, this updated information is transmitted to the Real-Time Data Interface through the Customer Relationship Management 112 and Commerce 110 applications for generating the real-time sales recommendations of the invention.

Referring to the Customer Attribute Template 600 of FIG. 6, four vector angles (V) (price-performance area definition), four monetary amount distances (d) (maximum price propensity to buy limit), and four availability lead times (LT) (maximum availability propensity to buy limit) are provided for each customer (C₁-C_{c}). In accordance with the invention, these vector angles (V), distances (d) and availability lead times (LT) may be initialized manually, or alternatively initialized dynamically.

As shown in FIGS. 8A and 8B, a capability/price diagram shows that the Selected Good or Service (GSₛ) is the origin or starting point of the sales recommendations. The monetary amounts (d) are the customers' or business partners' price tolerance for the sales recommendation for the selected good or service, whereby the four vector angles (V) and the four monetary amounts (d) determine the four distinct real-time sell spaces of the invention, namely, the up-sell space, the alternative-sell space 1, the alternative-sell space 2, and the down-sell space. The dimensions of capability, price and availability are preferably orthogonal to each other. Availability lead times information is the third dimension on which the present real-time sales recommendations are determined, and is the center of rotation for the partial solid cylinders shown in FIG. 9.

Referring to the diagrams of FIGS. 8A-9B, the Vector angle is referred to as (V_{wj}), whereby w=1 to 4 and j=1 to c, with GSₛ as the origin of the vector, with the angles defined in degrees or radians (determined by the seller). When the Vector Angle=zero (0), it is on the horizontal axis and directionally to the right. The vector angles (V_{wj}) determine the price-performance right and left lateral limits of each sell space. Distance of four monetary amounts is referred to as (dₓⱼ), whereby x=1 to 4, with GSₛ as the origin to define the area arc (propensity to buy limit). The availability lead times (LTₓⱼ) is the maximum lead time limit. In the preferred embodiment, the four distinct real-time sell spaces of the invention are defined as:

Up-Sell Space defined by GSₛ, right and left lateral limits defined by vector angles Vᵢⱼ and V₂ⱼ, the arc at distance dᵢⱼ from GSₛ and lead time LTᵢⱼ, whereby j=1 to c;

Alternative-Sell 1 Space defined by GSₛ, right and left lateral limits defined by vector angles V₂ⱼ and V₃ⱼ, the arc at distance d₂ⱼ from GSₛ and lead time LT₂ⱼ;

Down-Sell Space defined by GSₛ, right and left lateral limits defined by vector angles V₃ⱼ and V₄ⱼ, the arc at distance d₃ⱼ from GSₛ and lead time LT₃ⱼ; and

Alternative-Sell 2 Space defined by GSₛ, right and left lateral limits defined by vector angles V₄ⱼ and V₁ⱼ, the arc at distance d₄ⱼ from GSₛ and lead time LT₄ⱼ.

FIG. 8B illustrates the degree/radian circle and quadrants diagram 820 showing four quadrants labeled Roman Numeral I-IV. In accordance with the invention, the present rules for vector angle assignment to the quadrants are as follows:

Vector Angle V₁ⱼ is in either Quadrants I or II;

Vector Angle V₂ⱼ is in Quadrant I;

Vector Angle V₃ⱼ is in Quadrant IV; and

Vector Angle V₄ⱼ is in Quadrant III.

In view of the foregoing, an essential feature of the invention is that the four sell spaces defined above, in combination with the associated business rules for the vector angles of such sell spaces, determines which of the four quadrants the sell spaces will occupy. As such, within the degree/radian circle quadrant 820 of FIG. 8B, these sell spaces (in relation to the GSₛ) are as follows:

Up-Sell Space Area is in Quadrants I and/or II;

Alternative-Sell 1 Space Area is in Quadrants I and/or IV;

Down-Sell Space Area is in Quadrants III and IV; and

Alternative-Sell 2 Space Area is in Quadrants I, II and/or III.

Subsequently, wherein these vector angles (V), distances (d) and availability lead times (LT) have been manually initialized, based on customer order history and analytic scoring models (data mining), the manual inputs are overwritten by dynamic data derived from the Analytics component 121. As shown in FIG. 8B, the vector angles may be defined either in degrees or radians, whereby the seller specifies which of the two measurement units to employ and use consistently throughout the present process. In accordance with the invention, as orders booked at step 224 in the Commerce application 110, the Analytics component 121 is continually refreshed via the CRM application 112.

The Price component 126 is also dynamically updated at step 206 either daily or routinely in real-time when price actions or promotions are approved. The price is the second of two elements in determining the origin of the price-performance vector angles within the present method. For highly commoditized goods and/or services, the real-time price updates of the invention are crucial and advantageous for remaining competitive within a business industry. The pricing information is provided to the Real-Time Data Interface at step 208, as specified by the seller, through the ERP Application 114 and the Commerce Application 110.

FIG. 10 shows a Price Template 1000 as a matrix of all goods and services (offering portfolio) and customers (Cⱼ), whereby j=1 to c, where Customer 1 (C₁) is a “Public Customer” (anonymous), and customers 2 through “c” are registered customer segments, individual entitled customers or business partners. The price element (PRᵤⱼ) will vary for each good or service item (GSIᵤ) depending on the list (offering) price, promotional price, or contractual stipulations between the seller and customer. The Goods and Services Items is referred to as (GSIᵤ), whereby u=1 to p, where p is the total goods and services from all Goods and Services Capabilities Templates. Due to the potential breadth of prices, the origin on the price-performance plane in the Price Template 1000 differs vertically for the same good or service. In highly commoditized markets, prices will generally decline over time (drop vertically) unless there is a constrained marketplace situation.

The Availability component 127 is dynamically updated at step 207 either in batch mode from the scheduling application or in real-time. The scheduling application, with associated rules (e.g., tiering, brokering, etc.), provides seller's lead time availability messages to the Availability Template 1100 of FIG. 11, which shows a matrix of goods or services by customer tier. In FIG. 11, the Goods and Services Item is referred to as (GSIᵤ), whereby u=1 to p, where p is the total lift of all goods and services from all Goods and Services Capabilities Templates. The Customer Tier is referred to as (CT_{b}), whereby b=1 to r in integer increments and assigned based on company criteria, where “r” is the total number of customer tiers. The Availability, referred to as (AV_{ub}), is expressed as a lead time in days, either for shipment or arrival, and as an element of customer tier is determined using business rules contained within the scheduling application, and is an integer greater than zero (0).

In accordance with the invention, the Availability messages (e.g., lead time to either shipment or arrival) are updated from the scheduling application by customer tier and good or service into the Real-Time Data Interface at step 208. These availability messages are based on the netted supply available, which is the supply amount committed by the supplier minus any booked orders (i.e., preorders). Once a message type (e.g., to shipment or arrival) is selected, it is preferably used consistently throughout the present method. In the invention, as orders are booked at step 224 in the Commerce application 110, the Availability component 127 is advantageously continually refreshed, preferably in real-time, via the ERP application 114.

This batch update is particularly useful for selected data templates having increased daily changes that are refreshed more than once per day. The method is further advantageous since real-time data feeds from the components are provided to the real-time data interface such as, for example, pricing, availability, etc.

An essential feature of the batch update process of steps 201-207 is that these combined steps prepare the Real-Time Data Interface 124 for customer inquiries. In so doing, once a customer begins a learn and/or shop experience or session in the Commerce Application 110 at step 209, the Real-Time Data Interface 124 is set up to provide dynamic real-time sales recommendations to the seller's sales staff, customers or business partners. Once a customer begins a session, the customer then selects a good or service (GSₛ) either from an electronic medium, such as the Internet, or through an intermediary in step 210. This step is accomplished through the Commerce Application 110 and the ERP Application 114.

In step 211, once a good or service has been selected, sales recommendations may then be invoked through the Commerce Application 110. This is preferably accomplished by the present system automatically invoking sales recommendations in real-time upon selection of the original good or service. Alternatively, the customer may manually invoke sales recommendations such as, for example, by selecting an icon on a web page to trigger the selection of additional recommendations.

Steps 212-219 are then performed within the Real-Time Data Interface 124 of the invention. In step 212, the process accesses the Goods and Services Cross Reference Template 400 (FIG. 4A) within the Real-Time Data Interface 124 to identify additional Goods and Services Capabilities Templates 300 (FIG. 3) in step 213, also within the Real-Time Data Interface 124, for active consideration within of the present process. In so doing, it is ensured that the widest selection of goods and services are considered. Subsequently, the Goods and Services to Customer Cross Reference Template 500 (FIG. 5A) is accessed within the Real-Time Data Interface in step 214, and then in step 215 the process locates the applicable Customer Attribute Template 600 (FIG. 6) within the Real-Time Data Interface for the appropriate customer analytic parameters.

An essential feature of the invention is that at step 216, a real-time update from the ERP application 114 to the Availability component 127 feeds the latest availability information into the Availability Template 1100 (FIG. 11) within the Real-Time Data Interface 124. This is advantageous for dynamic businesses with large order volumes, either as single orders or as part of a multiple-period rollout plan, since these orders can rapidly deplete committed supply, thereby changing availability. This real-time availability information is critical to the selection of real-time sales recommendations in accordance with the invention. Alternatively, wherein a business entity has a high volume transaction ordering, such entity may modify its real-time capability to substantially real-time for periodically and continually refreshing the Real-Time Data Interface 124 based on predetermined order processing cycles or times. For example, if an order took 12 minutes from submission to scheduling, then the Availability Template to Real-Time Data Interface would be set at 12-minute intervals. While this embodiment is not preferred, it may be beneficial for a large number of input-output order transactions occurring in the present process.

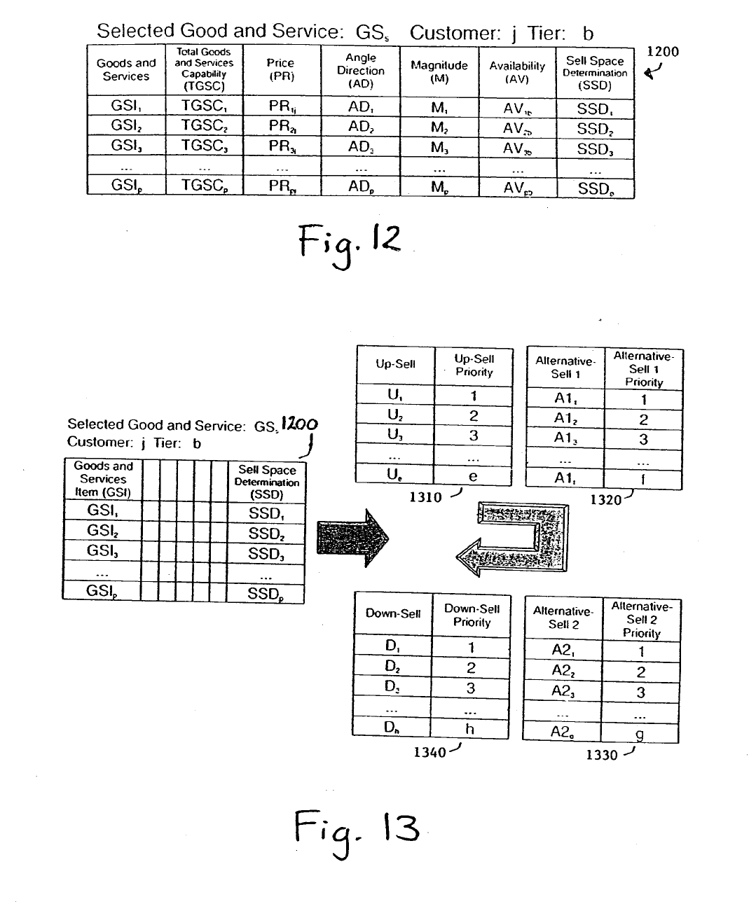

In step 217, the Sell Space Determination (SSD) outcomes use the Sell Space Determination Template 1200 of FIG. 12 within the Real-Time Data Interface. This Sell Space Determination Template 1200 is completed sequentially in real-time using the below factors.

The template is populated with the Selected Good or Service (GSₛ) and customer identifier (e.g., j) from the Commerce Application 110, and customer tier (CT_{b}) from the Customer Attribute Table 600, whereby y=s (the good or service selected by the customer, business partner or internal sales staff during the learn or shop experience) and b=1 to r in integer increments and assigned based on company criteria, where “r” is the total number of customer tiers.

The Goods and Services Items (GSIᵤ) and Total Goods and Services Capability (TGSC) calculations from the Goods and Services Capabilities Templates (GSCT) 300 are then added to the template 1200, whereby there may be more than one TGSC based on the Goods and Services Cross Reference Template 400, and whereby u=1 to p wherein p is the total of all goods and services from all Goods and Services Capability Templates, and a=1 to m. The price information for each Goods and Services Items (GSIᵤ) is added to template 1200 by the specific customer identifier from the Price Template 1000.

The Angle Direction (AD) (performance and price) is calculated using the Arc Tangent function within FIG. 12, wherein ADᵤ=ArcTan[(PRᵤⱼ-PRₛⱼ)/(TGSCᵤ-TGSCₛ)]. The Magnitude (M) (performance and price) is also calculated using Pythagorean's Theorem within FIG. 12, wherein Mᵤ=[(PRᵤⱼ-PRₛⱼ)²+(TGSCᵤ-TGSCₛ)²]^{1/2}. The current availability (AV_{ub}) for each Goods and Services Items (GSIᵤ) is added to template 1200 by the specific Customer Tier (CT) from the Availability Template 1100.

Once all of the above data is within the Sell Space Determination Template 1200, the Sell Space Determination (SSD) is derived for each Goods and Services Items (GSIᵤ). These Sell Space Determinations (SSD) (“N”, “U”, “A1”, “A2”, or “D”) are derived based on the below logic expressions and the specific customer analytic data (vector angles (V), distances (d) and lead times (LT)) from the Customer Attribute Template 600, whereby the Customer Attribute Template is selected on the basis of the Goods and Services to Customer Cross Reference Template 500. The five outcomes of the Sell Space Determination (SSD) are determined as follows:

Default is SSDₖ=N (No display) and remains “N” if [Mₖ=0, Mₖ>dₓⱼ or AV_{kb}>LTₓⱼ, where x=1 to 4 and j=1 to c];

SSDₖ=U (Up-Sell) if [V₂ⱼ<ADₖ<=Vₗⱼ, 0<Mₖ<=d₁ⱼ, and AV_{kb}<=LT₁ⱼ];

SSDₖ=Al (Alternative-Sell 1) if [(V₃ⱼ<ADₖ<=160) or (0<ADₖ<=V₂ⱼ), 0<Mₖ<=d₂ⱼ, and AV_{kb}<=LT₂ⱼ];

SSDₖ=A2 (Alternative-Sell 2) if [Vₗⱼ<ADₖ<=V₄ⱼ, 0<Mₖ<=d₄ⱼ, and AV_{kb}<=LT₄ⱼ]; and

SSDₖ=D (Down-sell) if [V₄ⱼ<ADₖ<=V₃ⱼ, 0<Mₖ<=d₃ⱼ, and AV_{kb}<=LT₃ⱼ].

Thus, in accordance with the invention, the three orthogonal dimensions of goods and services portfolio translation to the performance score, price and availability advantageously define four (4) three-dimensional partially solid cylinders of sales recommendations of differing sizes or volumes. Wherein the volumes of such partially solid cylinders are equal, the vector angles (V) must be at right angles to adjacent vector angles, the four distances (d) must be equal, and the availability Lead Times (LT) must also be equal. This occurrence would be highly unusual in an evolving marketplace environment. In so doing, an entity may allow the analytics component 121 to adjust the three orthogonal dimension factors based on the various business models and dynamics used in such entity's business.

Referring again to FIGS. 8A-9B, the four (4) three-dimensional partially solid cylinders of sales recommendations have the Selected Good or Service (GSₛ) (i.e., parent) as the origin, and the availability axis as the center of rotation for the partial cylinders. The volume of the sell space is determined by vector angles of the performance and price components, the lead time (LT) vector and the propensity to buy vector (d), which in turn, are determined through customer insight by applying analytics. As shown in the three-dimensional up-sell space of FIGS. 9A and 9B, the length of such sell space is the availability lead time limit (LT₁ⱼ), whereby j=1 to c, the radius is the distance or propensity to buy limit (d₁ⱼ) and the right and left limits are vector angles V₁ⱼ and V₂ⱼ, respectively, the price and performance limits. FIG. 9B shows several possible real-time up-sell child relationships (denoted by “U”), or real-time up-sell alternatives, within the three-dimensional domain of the present sales recommendations for the Selected Good or Service (GSₛ). The number and sequence of up-sell sales recommendations will be based on the application of business rules contained in the Parameters component 123 and are used in Template 1310 of FIG. 13. In view of the above description, it should be appreciated that the three remaining partially solid cylinders for down-sell and the left and right alternative-sell spaces are correspondingly defined. The four sell spaces are parallel to each other along the axis of rotation (availability), but may be of varying angles (price-performance) and radii (propensity to buy). The quantitative parameters for each sell space are determined in the Sell Space Determination Template 1200 of FIG. 12, which is also partially shown in FIG. 13.

In continuing the process flow, once the update of the sell area priority templates, which are based on rules, have been determined by the real-time data interface in step 217, the process continues to step 218 wherein the priority placement of real-time sales recommendations into the Sell Space Priority Templates 1300 shown in FIG. 13 are determined within the real-time data interface. In so doing, three major data elements are used: (1) Goods and Services Item (GSIᵤ), whereby u=1 to p, where p is the total of all goods and services from all Goods and Services Capability Templates; (2) Selected Good or Service (GSₛ), where y=s, is the number of the good or service selected by the customer, business partner or internal sales staff during the learn or shop experience; and (3) Sell Space Determination (SSDᵤ) of U, A1, A2, and D from the Sell Space Determination Template 1200. The process flow then segments the Sell Space Determination factors into the four (4) Sell Space Priority Templates 1310-1340 of FIG. 13 described below.

Referring to FIG. 12, all Sell Space Determination (SSDᵤ) factors denoted as “N” (which denotes “No Display”) are excluded from further processing, and advantageously narrows down the real-time sales recommendations. Each Goods and Services Item (GSIᵤ) that is not denoted by an “N”, is placed into one of the four (4) Sell Space Priority Templates 1310-1340 of FIG. 13, whereby such placements are based on their SSD factor denoted as follows:

“U” (up-sell) will be placed in the up-sell template 1310 with priorities 1 to e;

“A1” (alternative-sell 1) will be placed in the alternative-sell 1 template 1320 with priorities 1 to f;

“A2” (alternative-sell 2) will be placed in the alternative-sell 2 template 1330 with priorities 1 to g; and

“D” (down-sell) will be placed in the down-sell template 1340 with priorities 1 to h.

Once the four Sell Space Priority Templates 1310-1340 have been completed in the real-time data interface 124, each set of real-time sales recommendations is sorted therein in descending priority order based on a current set of predefined business rules residing within the Parameters File 123. Preferably, these predefined business rules are determined by the seller and may be set based on marketplace conditions. For example, the business rules may be based on revenue generation, profit contribution, availability, performance capability, solution compatibility, and the like, and even any combinations thereof. The sequence of sales recommendations is preferably up-sell, alternative-sell 1, alternative-sell 2, and down-sell. The business rules may also set a number of real-time sales recommendations to present to the customer or business partner. For example, the entity may specify a maximum of three up-sell, two alternative-sell 1, and one alternative-sell 2 and down-sell sales recommendations. In this case, the entity may provide up to seven sales recommendations, assuming there are sufficient number of recommendations in each sell space. The entity provides business rules based upon marketplace conditions or business objectives. Business practices may also vary by country, and would be appropriately codified within the Parameters File component 123. As such, the present sales recommendations may be graphically displayed to a user based on ascertained priorities and/or number of sales recommendations to be presented. In some instances, there may be no SSD factor real-time sales recommendations for a particular sell space. Also, in certain situations a seller may choose to exclude specific sales recommendations by setting either dₓⱼ=0 or LTₓⱼ=0, whereby x=1 to 4 and j=1 to c.

The real-time sales recommendations (up-sell, alternative-sell, and down-sell) generated within the real-time data interface 124 are transmitted there from and to the Commerce application 110 in step 219. In so doing, in step 220, the customer, business partner or internal sales staff is now able to view these sales recommendations, and the user can then choose to either retain the originally selected Good or Service (GSₛ) and continue the shopping experience, or to select one of the sales recommendations and place it into the shopping cart within the Commerce application 110.

The user then determines if additional shopping is required in step 221. For example, if none of the sales recommendations are suitable, the user may seek another good or service from the seller's catalog. Wherein the user seeks additional shopping, the “Yes” branch is followed and the process flow continues to step 209, and steps 209 through 220 are repeated. However, if the user has concluded the shopping experience at step 221, the “No” branch is followed and the process flow continues to step 222. In step 222, the customer or business partner makes a purchase decision. Following the “No” branch, the user stops the buy experience at step 223, but may return at a later time to learn more about the seller's goods or services, thereby restarting the process at step 209. For those skilled in the art, the user could save the shopping cart and return to the saved shopping cart at a latter time or date.

Following the “Yes” branch, the customer or business partner decides to purchase the goods and/or services within the Commerce application's shopping cart in step 222. The order is then submitted to the seller via the appropriate means in step 224. In step 205, once the order has been placed, the Analytics component 121 is updated in real-time via the CRM application 112 with the purchase history for subsequent use in accordance with the present invention. The netted available supply is decremented in the ERP application 114, and as required, a change may be submitted to the Availability component 127.

This method can also be used to make sales recommendations for solutions, the combination of two or more goods and services. The solution may be from two or more different product families but their operability or compatibility relationships between each other are established in the Goods and Services component 128. For example, a solution may be comprised of a computer, storage device, and an education session. When a solutions sales recommendation request is initiated in step 211, the method would be executed for all of the products and services. The additional element is a set of compatibility business rules that exclude certain combinations of sales recommendations from being made at step 218. The seller has the option of displaying sales recommendations at a solution level (preferred) or individual level. In accordance with the invention, sellers are no longer confined to a limited number of predetermined sales paths. The user's iterative learning and shopping needs, in combination with the real-time and on demand display capabilities of appropriate real-time sales recommendations, advantageously avoids the prior art problems associated with conventional parent-child relationships such as, for example, the problems associated with parent-child pair breakage.

Thus, it should be appreciated that the invention beneficially provides sales recommendations that are reliable, dynamic, provided in real-time, rules driven, supply based and synchronized across all channels or routes to market. These routes to market include business partners, account representatives, service consultants, and/or TeleWeb. The invention combines the full complement of primary and orthogonal buying characteristics of performance, price, availability and market data analytics (i.e., business and customer insight) to condition demands in real-time. In so doing, up-to-date customer tailored parent-child(ren) pairs of goods and/or services sales recommendations are provided that are of value to both the customer and the seller, thereby improving productivity. This sales recommendation invention accounts for simple and complex (i.e., nonlinear, exponential, etc.) performance and price relationships using a variety of types of pricing including, but not limited to, list price, contractual entitlement pricing, special bid pricing, promotional pricing, and the like. The invention also converts performance and price relationships in the Cartesian plane (rectangular coordinate system) to complex numbers (Polar coordinates) using the Arc Tangent function and Pythagorean Theorem for analysis and selection, as well as allows internal users to define the Arc Tangent output either as degrees or radians. One or more parent-child(ren) pairs of sales recommendations may be displayed on the user interface in a prioritized manner, based on seller-defined business rules.

The invention overcomes the problems associated with static parent-child(ren) pairs, including the breakage of such static pairs, by providing dynamic, real-time sales recommendations that are responsive (i.e., able to sense and respond to changing market place conditions), variable (i.e., meet new informational requirements instantaneously), focused (i.e., concentrate on delivering value) and resilient (i.e., anticipate issues in real-time). The goals of the invention include, but are not limited to, driving revenue and profit growth, reducing inventory liability, ensuring sale retention, retaining both customer loyalty and satisfaction, and the like.

It should be appreciated that components of the present invention may be embodied as a computer program product stored on a program storage device. These program storage devices may be devised, made and used as a component of a machine that utilizes optics, magnetic properties and/or electronics to perform certain of the method steps of the present invention. Such program storage devices may include, but are not limited to, magnetic media such as diskettes or computer hard drives, magnetic tapes, optical disks, Read Only Memory (ROM), floppy disks, semiconductor chips and the like. A computer readable program code means in known source code may be employed to convert certain of the method steps described below. This computer readable program code contains instructions embodied in tangible media, such as floppy disks, CD-ROMS, hard drives, or any other computer-readable storage medium, wherein, when the computer program code is loaded into and executed by a computer, the computer becomes an apparatus for practicing the invention.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method for providing dynamic, real-time sales recommendations comprising: a user selecting a sales offering;
transmitting data feeds to a real-time data interface;
transmitting said selected sales offering to said real-time data interface; and
generating real-time sales recommendations within said real-time data interface using said selected sales offering and said data feeds.

2. The method of claim 1 wherein said data feeds comprise a combination of currently available sales offering pricing, availability, performance and data-mined analytics information.

3. The method of claim 2 wherein said data-mined analytics information is selected from the group consisting of sales offering demand history, user demand history, firmographics, psychographics, place of purchase, company size, territories, industries, postal codes, user information, user input, user feedback, user buying behaviors and characteristics, and secondary buying characteristics.

4. The method of claim 1 wherein said data feeds are selected from the group consisting of real-time data feeds, batch data feeds, and combinations thereof.

5. The method of claim 1 wherein said real-time data interface generates said real-time sales recommendations by determining price-performance vector angles that define four distinct sell spaces comprising an up-sell space, a down-sell space, a first alternative-sell space, and a second alternative-sell space.

6. The method of claim 5 wherein said sales recommendations are selected from the group consisting of an up-sell, a down-sell, an alternative-sell and combinations thereof.

7. The method of claim 6 wherein business rules determine which of said four distinct sell spaces said real-time sales recommendations will occupy.

8. The method of claim 1 wherein said user is selected from the group consisting of a customer, business partner, sales representative, and combinations thereof.

9. The method of claim 1 wherein said sales offering is selected from the group consisting of a good, a service and combinations thereof.

10. The method of claim 1 wherein said real-time sales recommendations comprise a plurality of sales recommendations linked together in real-time to provide a substantially unbreakable chain real-time sales recommendations.

11. The method of claim 1 further including the step of tailoring said real-time sales recommendations in response to wants and needs of said user using said data feeds.

12. The method of claim 1 further including the step of continually updating said data feeds using currently available sales offering information.

13. The method of claim 12 wherein steps for continually updating said data feeds comprise:
performing a batch update of said data feeds using said currently available sales offering information;
refreshing table structures using said updated data feeds;
transmitting said selected sales offering and said data structures to said real-time data interface; and
generating said real-time sales recommendations using said selected sales offering and said data structures.

14. The method of claim 13 wherein said step of performing said batch update comprises:
updating sales offering pricing information;
updating sales offering availability information;
updating sales offering performance information;
updating data-mined analytics information; and
transmitting said updated sales offering pricing, availability, performance and data-mined analytics information to said real-time data interface for generating said real-time sales recommendations.

15. The method of claim 1 wherein said real-time data interface employs business rules for generating said real-time sales recommendations.

16. The method of claim 15 wherein said business rules are used to provide said user with a select group of said real-time sales recommendations.

17. The method of claim 1 wherein said real-time sales recommendations reside within sales offering families selected from the group consisting of a single sales offering family, a plurality of similar sales offering families, a plurality of different sales offering families and combinations thereof.

18. The method of claim 1 further including initiating a request for a solution sales recommendation to satisfy said user's wants and needs, whereby at least two of said real-time sales recommendations, when combined together, comprise said solution sales recommendation.

19. A system for providing dynamic, real-time sales recommendations comprising:
a pricing component for providing pricing information in for a sales offering;
an availability component for providing a netted supply available of said sales offering;
a performance component for providing performance and capabilities data relating to said sales offering;
an analytics component for providing data-mined analytics information; and
a real-time data interface for generating real-time sales recommendations based on said sales offering and said pricing information, said netted supply available, said performance and capabilities data, and said data-mined analytics information.

20. A program storage device readable by a processor capable of executing instructions, tangibly embodying a program of instructions executable by the processor to perform method steps for providing dynamic, real-time sales recommendations, said method steps comprising:
a user selecting a sales offering;
transmitting data feeds to a real-time data interface;
transmitting said selected sales offering to said real-time data interface; and
generating real-time sales recommendations within said real-time data interface using said selected sales offering and said data feeds.
